(19) United States
(12) Patent Application Publication
(10) Pub. No.: US 2008/0126026 A1
(43) Pub. Date: May 29, 2008

(54) FFT/IFFT processor and intellectual property builder

(75) Inventors: Shuenn-Yuh Lee, Ming-Hsiung (TW); Wen-Zhi Qiu, Ming-Hsiung (TW); Jia-Gan Chen, Ming-Hsiung (TW)

Correspondence Address: BIRCH STEWART KOLASCH & BIRCH, PO BOX 747, FALLS CHURCH, VA, 22040-0747, US

(73) Assignee: Shuenn-Yuh Lee

(21) Appl. No.: 11/518,118

(22) Filed: Sep. 11, 2006

(51) Int. Cl. G06F 17/14; G06F 17/10

(52) U.S. Cl. 703/2; 708/404

(57) ABSTRACT

A FFT/IFFT processor and an intellectual property (IP) builder are disclosed. Which include a circuit applying the mixed-radix algorithm and a parametric graphic user interface (GUI). The circuit is for a parametric IP builder. The parametric GUI is for user to complete hardware design and functional test of FFT/IFFT processor by software. The IP builder could accelerate the progress of processor design and SOC integration.

### BACKGROUND

1. Field of Invention

The present invention relates to a FFT/IFFT processor and an intellectual property builder. More particularly, the present invention relates to a FFT/IFFT processor and an intellectual property builder, which is suitable for user's setting up parameters.

2. Description of Related Art

Fast Fourier Transform/Inverse Fast Fourier Transform (FFT/IFFT) are extremely extensive in the fields of digital signal processors (DSP) and communication technologies.

All portable and communication systems modulate signal with orthogonal frequency division multiplexing (OFDM), which like wireless local area network (WLAN), x digital subscriber line (xDSL) or MP3 player regard FFT and IFFT as core technologies. Thus, developing a FFT/IFFT intellectual property (IP) builder suitable for kinds of systems is very helpful for reducing developing processes and time of products.

Because of application of FFT/IFFT is very extensive, therefore the range of specification is wide-ranging, too. For example, calculating point number of FFT/IFFT is N=2ⁿ (n≧6 and n≦13), which means calculating point number N could be equal to 64, 128, 256, 512, 1024, 2048, 4096 or 8192 in various systems. For instance, the OFDM system of asymmetric digital subscriber line (ADSL) uses 512 sub carriers for modulation, so an FFT/IFFT hardware with 512 calculating point numbers is necessary for modulation and demodulation operations. Otherwise, an IEEE standard of wireless communication 802.11a needs to handle 64 sub carriers. Digital video broadcasting—terrestrial (DVB-T) needs to deal with 8192 sub carriers at most.

Because of the chip area of FFT/IFFT hardware structure is direct ratio to the calculating point number of FFT/IFFT. If the calculating point number N is greater than 1024 (namely n is greater than 10), then the necessary chip area is too big to be produced.

The FFT/IFFT structure with shared memory is recursive for reducing chip area efficiently. But, when a radix-2 algorithm applied and N is greater than 2048, necessary clock cycles of FFT/IFFT structure in a chip will increase power consumption of the chip. A radix-4 algorithm could lower the necessary clock cycles of FFT/IFFT structure with shared memory, but which could not apply to all FFT/IFFT operations with N=2ⁿ (The radix-4 algorithm must be applied to FFT/IFFT operations with N=4ⁿ).

### SUMMARY

An intellectual property builder includes a graphic user interface, a behavioral model, a register transfer level model, an upper level connecting module and a test module.

The graphic user interface sets a plurality of FFT/IFFT parameters, and providing a value of signal to noise ratio (SNR). The behavioral model detects a truncation error of hardware at a stage of system simulation. The register transfer level model, comprises a core circuit module, the core circuit module includes a radix-2 mode FFT/IFFT processor, a radix-2² mode FFT/IFFT processor, a radix-2³ mode FFT/IFFT processor and a mixed-radix controller, the register transfer level model could generate a register transfer level code. The upper level connecting module connects a plurality of hardware module to obtain a circuit corresponding the plurality of FFT/IFFT parameters. And a test module includes a plurality of test mode for testing the register transfer level code.

A FFT/IFFT processor includes a memory, a butterfly processor unit and a memory control circuit.

The butterfly processor unit has a pipeline multiple-path delay commutator, and the butterfly processor unit has a capability of pipeline mixed-radix calculation in accordance with pipeline multiple-path delay commutator. The memory control circuit includes a memory write circuit and a memory read circuit, and a shared memory structure could be composed of the memory write circuit and the memory read circuit.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A illustrates a flowchart of producing an FFT/IFFT processor of an embodiment of the present invention;

FIG. 1B illustrates a flowchart of generating necessary parameters of the FFT/IFFT processor by using an intellectual property (IP) builder of the embodiment of the present invention;

FIG. 2 illustrates a schematic diagram of a window interface of the IP builder of the embodiment of the present invention;

FIG. 3 illustrates a schematic diagram of a setting FFT/IFFT parameters window interface of the IP builder of the embodiment of the present invention;

FIG. 4 illustrates a schematic diagram of a setting test bench parameters window interface of the IP builder of the embodiment of the present invention;

FIG. 5 illustrates a schematic diagram of a generating synthesis script sample window interface of the IP builder of the embodiment of the present invention;

FIG. 6 illustrates a schematic diagram of a setting window interface for output files of the IP builder of the embodiment of the present invention;

FIG. 7 illustrates a schematic diagram of an end-screen window interface of the IP builder of the embodiment of the present invention;

FIG. 8A illustrates a schematic diagram of a butterfly processor unit switching to radix-2³ mode of the embodiment of the present invention;

FIG. 8B illustrates a schematic diagram of a butterfly processor unit switching to radix-2² mode of the embodiment of the present invention;

FIG. 8C illustrates a schematic diagram of a butterfly processor unit switching to radix-2 mode of the embodiment of the present invention; and

FIG. 9 shows a schematic diagram of a memory address generating circuit of the embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

While the specification concludes with claims defining the features of the invention that are regarded as novel, it is believed that the invention will be better understood from a consideration of the following description in conjunction with the figures, in which like reference numerals are carried forward.

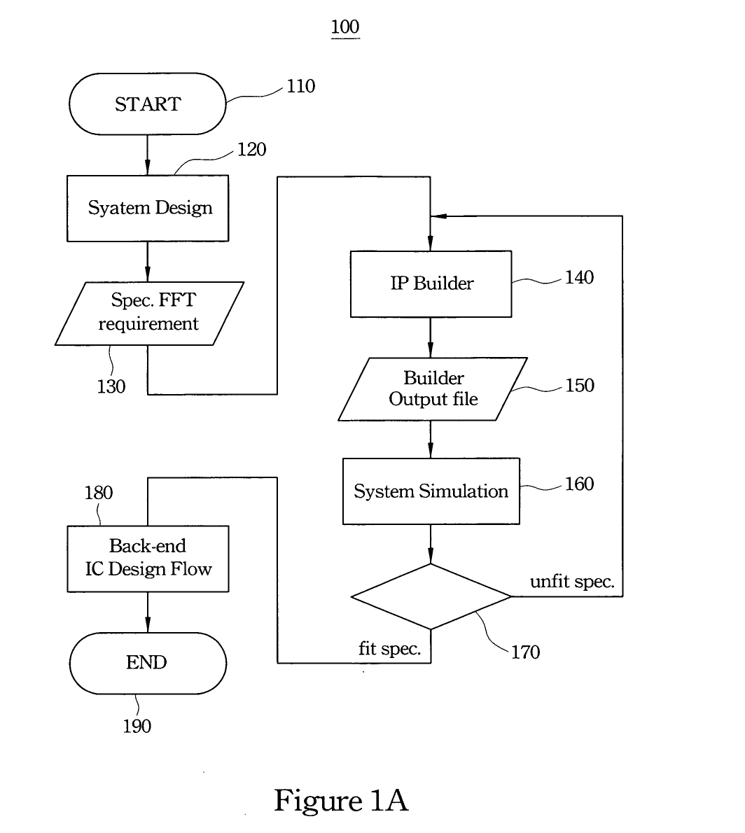

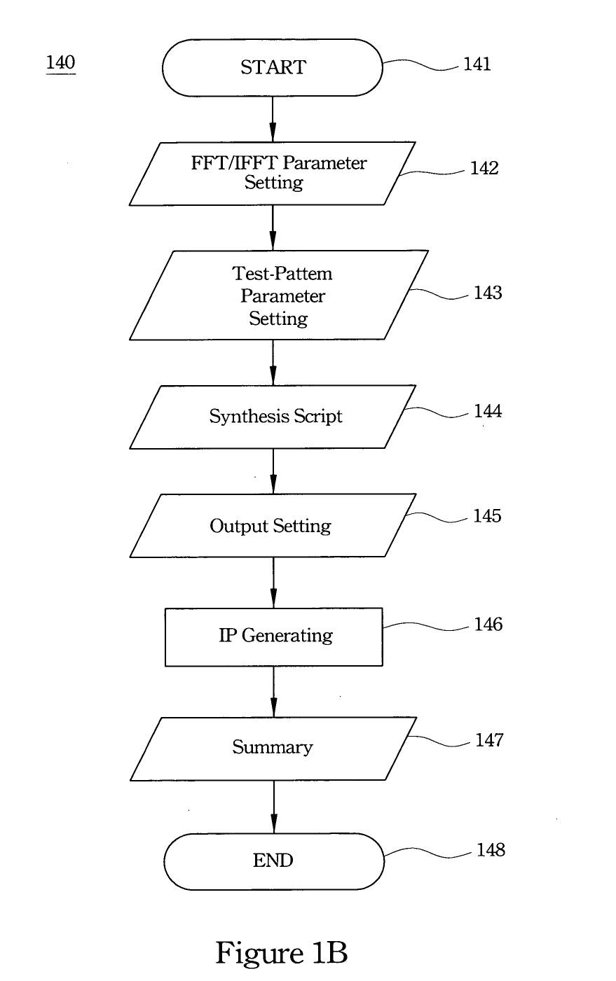

Refer to FIG. 1A, which illustrates a flowchart of producing an FFT/IFFT processor of an embodiment of the present invention. A process 100 comprises 9 steps below:

A step 110 is to start the process 100. A step 120 is to execute a system design. A step 130 is to set specifications of FFT/IFFT. A step 140 is to execute an intellectual property (IP) builder. A step 150 is to output file from the IP builder. A step 160 is to simulate and verify the system. A step 170 is to confirm whether the specifications of FFT/IFFT in the step 130 could be fitted. A step 180 is to execute back-end IC design flow. A step 190 is to end the process 100.

The step 120 includes executing the system design with high-level programming language, for example, like C, C++ or Matlab etc. The purpose of the step 120 is to find relative parameters of a FFT/IFFT processor, such as a FFT/IFFT system. The relative parameters are a carrier number of OFDM, a signal to noise ratio and an OFDM symbol duration etc.

The step 130 is to set specifications of FFT/IFFT in accordance with the parameters found in the step 120. Perform conversions from the parameters found in the step 120 to necessary FFT/IFFT parameters of the IP builder. For instance:

(a) Determine a FFT/IFFT calculating point number in accordance with the carrier number of OFDM.

(b) Determine a FFT/IFFT word length and a FFT/IFFT coefficient length in accordance with the signal to noise ratio.

(c) Determine a FFT/IFFT operating frequency in accordance with the OFDM symbol duration.

The step 140 is to input the necessary FFT/IFFT parameters from the step 130 into the IP builder, and calculates various FFT/IFFT parameters by the IP builder. The step 150 is to output file from the IP builder. There are 4 kinds of output files could be selected:

(1) a register transfer level code (RTL code);

(2) a test bench;

(3) a synthesis script; and

(4) a C programming language model code.

The step 160 is to simulate and verify the system. Input the C programming language model code into the system for simulation, and verify whether the error caused by hardware resolution could be accepted by the system. The step 170 is to confirm whether the results of simulation in the step 160 could be fitted the specifications of FFT/IFFT in the step 130; if yes, then continue to next step; if no, then back to the step 140 for modifying the setting of IP builder to fit the original setting specifications of FFT/IFFT.

The step 180 is to execute back-end IC design flow. Using the RTL code outputted by the IP builder to execute system-on-chip (SOC) integration or cell-base IC design.

Refer to FIG. 1B, which illustrates a flowchart of generating necessary parameters of the FFT/IFFT processor by using an intellectual property (IP) builder of the embodiment of the present invention. The step 140 comprises 8 sub-steps below:

A step 141 is to start the step 140. A step 142 is to set FFT/IFFT parameters. A step 143 is to set parameters of the test bench. A step 144 is to generate the synthesis script. A step 145 is to set the output file. A step 146 is to generate an intellectual property (IP). A step 147 is to show a summary of executing result of the IP builder. A step 148 is to end the step 140.

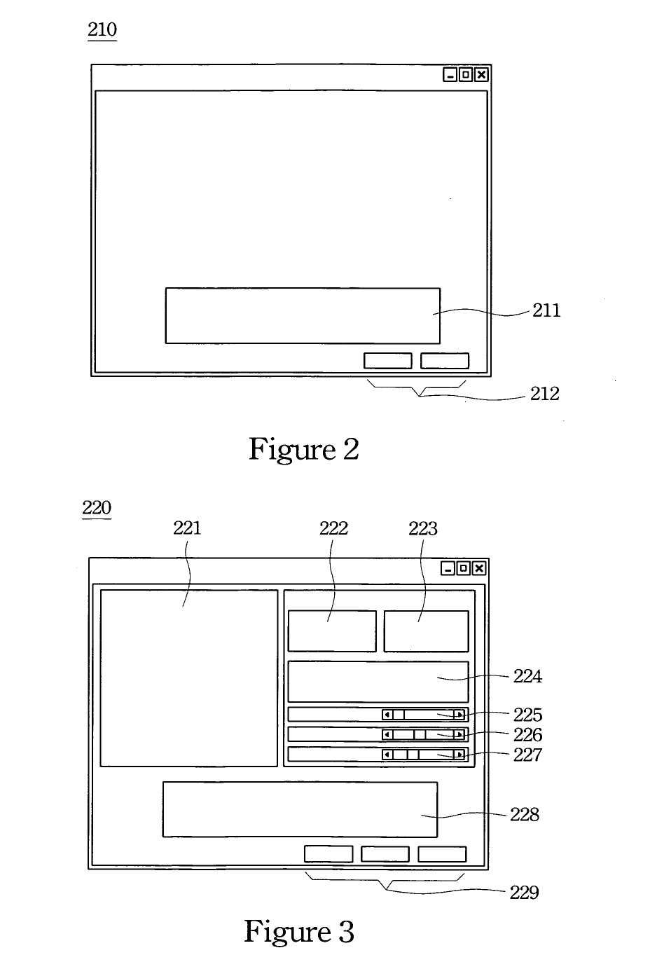

Refer to FIG. 2, which illustrates a schematic diagram of a window interface of the IP builder of the embodiment of the present invention. A screen 210 includes a suggestion 211 and a plurality of function keys 212. The suggestion 211 provides a description about how to use the screen 210. The plurality of function keys 212 include “Next” (proceed to next step) and “Cancel” (exit from the IP builder) functions.

Refer to FIG. 3, which illustrates a schematic diagram of a setting FFT/IFFT parameters window interface of the IP builder of the embodiment of the present invention. A screen 220 includes an IP icon 221, an IP core type 222, a signal to quantization noise ratio (SQNR) calculation 223, a memory type selection 224, a FFT/IFFT calculating point number 225, a FFT/IFFT word length 226, a FFT/IFFT coefficient length 227, a suggestion 228 and a plurality of function keys 229.

The IP icon 221 illustrates all functions of pins of the IP, and the IP is namely a FFT/IFFT processor. The IP core type 222 includes 3 types could be selected, which are FFT, IFFT and FFT/IFFT. The memory type selection 224 provides 3 memory types to be selected:

(1) synthesis from registers;

(2) TSMC 0.35 μm (micro-meter) two ports RAM; and

(3) UMC 0.18 μm dual ports RAM.

The FFT/IFFT calculating point number 225 is namely a FFT/IFFT size. The options of the FFT/IFFT calculating point number 225 include 2ⁿ kinds of FFT/IFFT calculating point numbers (n is an integer from 6 to 13). So, the FFT/IFFT size could be 64, 128, 256, 512, 1024, 2048, 4096 or 8192.

The range of the FFT/IFFT word length 226 is from 5 bits to 18 bits. The range of the FFT/IFFT coefficient length 227 is from 5 bits to 18 bits, too. The suggestion 228 provides a description about how to use the screen 220. The plurality of function keys 229 include “Previous” (back to the screen 210), “Next” (proceed to next step) and “Cancel” (exit from the IP builder) functions.

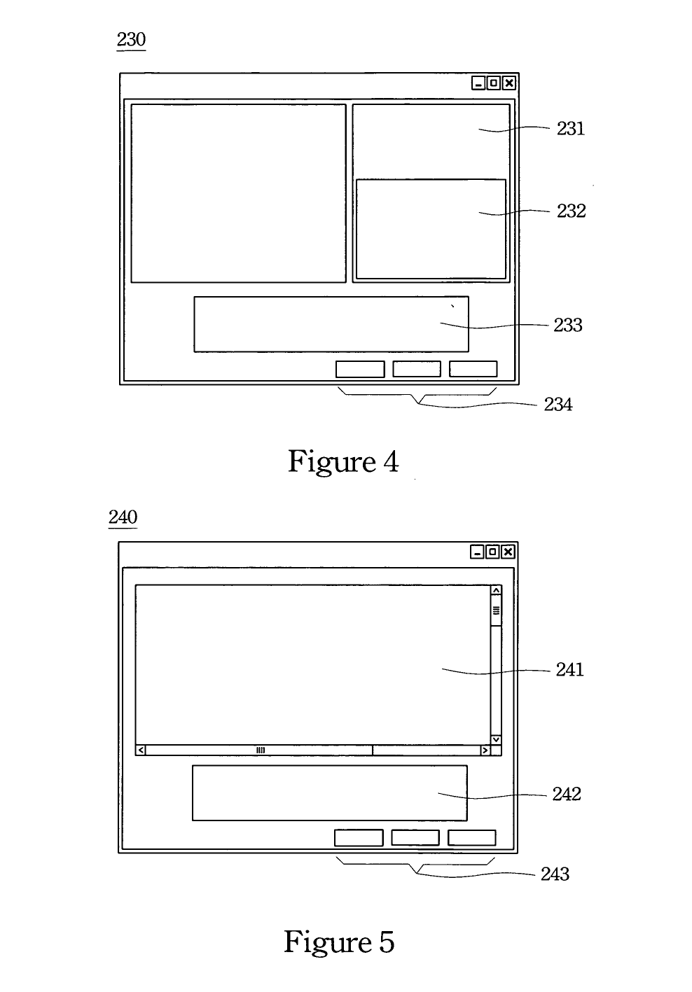

Refer to FIG. 4, which illustrates a schematic diagram of a setting test bench parameters window interface of the IP builder of the embodiment of the present invention. A screen 230 includes a clock cycle time 231, a test mode 232, a suggestion 233 and a plurality of function keys 234.

The default value of the clock cycle time 231 is 40 μs (micro-second). The test mode 232 includes 3 kinds of test patterns below:

(1) sine pattern: sampling N points to a sine wave for a input signal of FFT/IFFT;

(2) cosine pattern: sampling N points to a cosine wave for a input signal of FFT/IFFT; and

(3) random pattern: sampling N points to a random data for a input signal of FFT/IFFT.

The number of N point is a multiple of FFT/IFFT size and could be determined by users. Otherwise, users of the IP builder could use one or more test pattern for testing. The suggestion 233 provides a description about how to use the screen 230. The plurality of function keys 234 include “Previous” (back to the screen 220), “Next” (proceed to next step) and “Cancel” (exit from the IP builder) functions.

Refer to FIG. 5, which illustrates a schematic diagram of a generating synthesis script window interface of the IP builder of the embodiment of the present invention. A screen 240 includes a synthesis script sample 241, a suggestion 242 and a plurality of function keys 243.

The synthesis script sample 241 could be modified for necessary, such as parameters or instructions in the synthesis script sample 241: “clock”, “input delay”, “output delay” and “output load” etc. The suggestion 242 provides a description about how to use the screen 240. The plurality of function keys 243 include “Previous” (back to the screen 230), “Next” (proceed to next step) and “Cancel” (exit from the IP builder) functions.

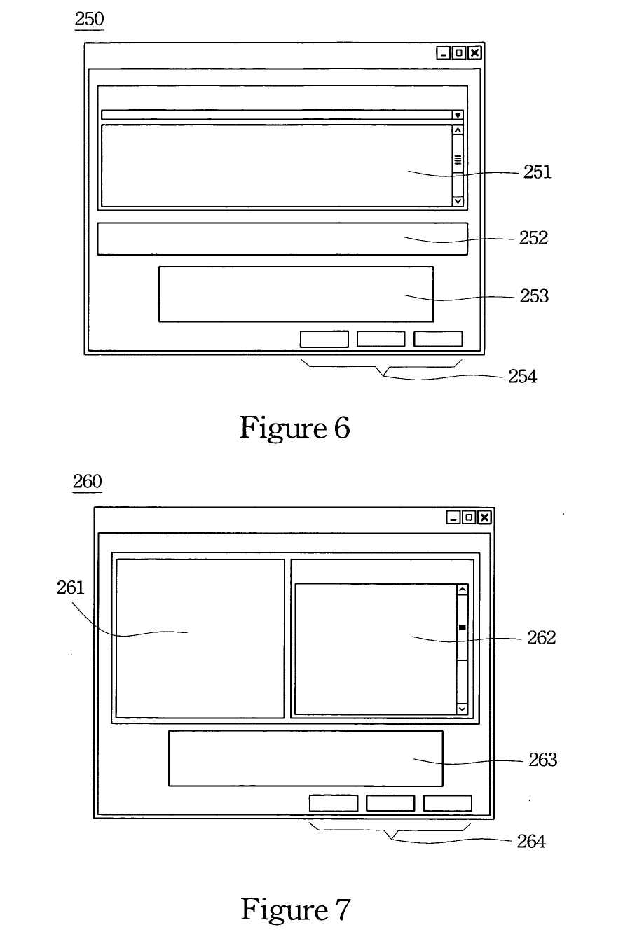

Refer to FIG. 6, which illustrates a schematic diagram of a setting window interface for output files of the IP builder of the embodiment of the present invention. A screen 250 includes an output file path 251, an output file selection 252, a suggestion 253 and a plurality of function keys 254.

The output file path 251 is to set output path of file generated by the IP builder. The output file selection 252 includes 4 kinds of output files below:

(1) a register transfer level code (RTL code) file, which could be synthesized by the IP builder;

(2) a test bench file, which could automatically compare a hardware output test signal synthesized by RTL code and a C programming language model code for verifying whether the completed hardware (The hardware is namely a IP or a FFI/IFFT processor) is correct;

(3) a synthesis script file, outputting the synthesis script sample 241 to a file; and

(4) a C programming language model code file, including a FFT/IFFT function model composed of the C programming language. The FFT/IFFT function model could simulate all functions of hardware and provide effects caused by limited bits of hardware.

The suggestion 253 provides a description about how to use the screen 250. The plurality of function keys 254 include “Previous” (back to the screen 240), “Next” (proceed to next step) and “Cancel” (exit from the IP builder) functions.

Refer to FIG. 7, which illustrates a schematic diagram of an end-screen window interface of the IP builder of the embodiment of the present invention. A screen 260 includes an input parameters list 261, an output file list 262, a suggestion 263 and a plurality of function keys 264.

The output file list 262 lists all prepared output files in a structure tree for users of the IP builder to check. The suggestion 263 provides a description about how to use the screen 260. The plurality of function keys 264 include “Previous” (back to the screen 250), “Next” (proceed to next step) and “Cancel” (exit from the IP builder) functions.

Moreover, an intellectual property builder of another embodiment of the present invention includes a graphic user interface, a behavioral model, a register transfer level model, and an upper level connecting module.

The intellectual property builder is operated through the graphic user interface for setting a plurality of FFT/IFFT parameters. Furthermore, provides a value of signal to noise ratio (SNR) for determining the word length and the coefficient length, and outputted a register transfer level code file, a test bench file, a synthesis script file and a C programming language model code for users demanding.

The behavioral model provides a C/C++ programming language function model for detecting a truncation error of hardware at a stage of system simulation.

The register transfer level model provides a RTL code, namely a Verilog code, could be synthesized. The RTL code could be implemented by a application specific integrated circuit (ASIC) or a system-on-chip (SOC) integration. The register transfer level model includes a core circuit module, and the core circuit module includes a radix-2 mode FFT/IFFT processor, a radix-2² mode FFT/IFFT processor, a radix-2³ mode FFT/IFFT processor and a mixed-radix controller. Every mode aforementioned is parametric for the register transfer level model generating a corresponded register transfer level code.

The upper level connecting module connects a plurality of hardware module to obtain a circuit corresponded the plurality of FFT/IFFT parameters.

The test module could verify whether the RTL code produced by the IP builder possesses FFT/IFFT hardware functions. The test module has 3 kinds of test patterns such as the sine pattern, the cosine pattern and the random pattern. The test signals of aforementioned test patterns input into a synthesized hardware by the RTL code and a FFT/IFFT description completed by C programming language respectively, then compare automatically for sure that the RTL code is correct.

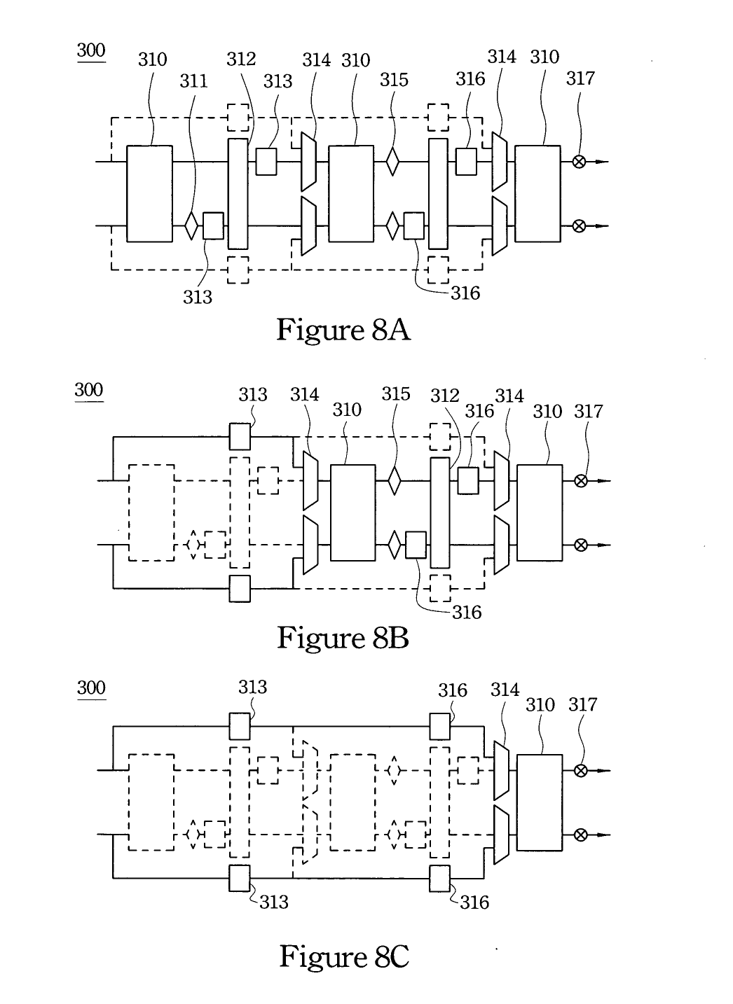

Refer to FIG. 8A, 8B and 8C, which illustrate schematic diagrams of a butterfly processor unit switching to radix-2³ mode, radix-2² mode and radix-2 mode of the embodiment of the present invention respectively.

A butterfly processor unit 300 includes a radix-2³ structure and a pipeline multiple-path delay commutator (MDC). Because of the MDC has a switching capability, so the butterfly processor unit 300 needs not additional radix-2² and radix-2 hardware structures and has a pipeline mixed-radix calculating capability with radix-2³ mode, radix-2² mode and radix-2 mode.

The devices illustrated by continuous lines in FIG. 8A, 8B and 8C represent they are in action. The devices illustrated by dash lines (or hidden lines) in FIG. 8A, 8B and 8C represent they are not in action.

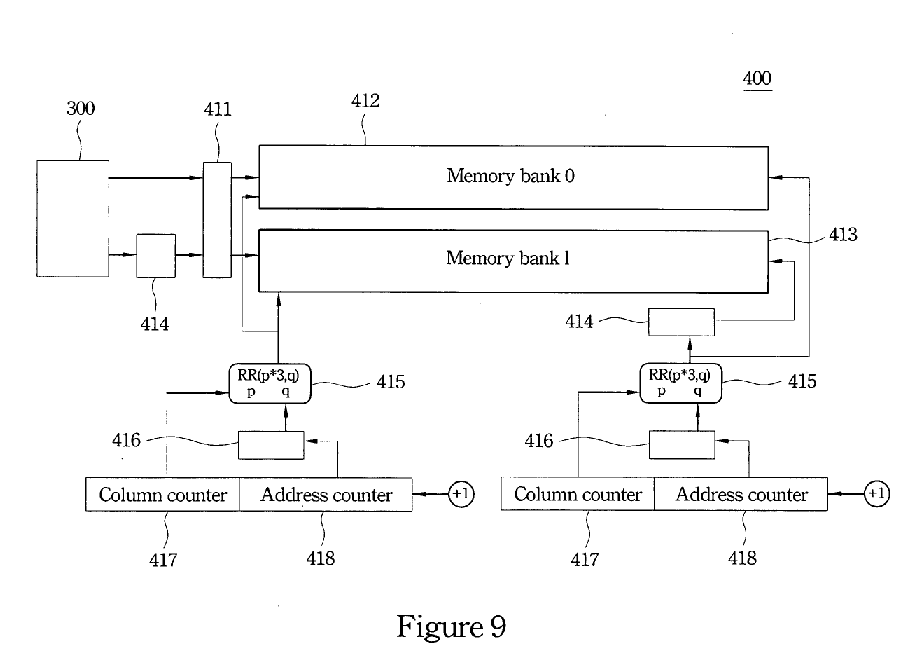

FIG. 9 shows a schematic diagram of a memory address generating circuit of the embodiment of the present invention. A memory address generating circuit 400 includes two parts: a memory write circuit and a memory read circuit.

(1) The Memory Write Circuit:

Because of the output order of the butterfly processor unit 300 has a action of bit reverse, so sequences outputted by the butterfly processor unit 300 will be changed. Hence, a switch 411 and a delay 414 must be added at output terminal of the butterfly processor unit 300, and sequences parallel processing will be achieved at the same time.

(2) The Memory Read Circuit:

Observing the binary form of butterfly sequences prepared to input into 2 input terminals of the butterfly processor unit 300, wherein a (R-p*3) bit in a column counter 417 is 1 or 0, and R is a total bit number of the column counter 417 and a address counter 418, and p is a column number of a butterfly sequence. Therefore, the (R-p*3) bit could be a decoding bit of memory bank selection, which means butterfly sequences could be selectively read by a memory bank 412 or a memory bank 413.

Furthermore, the memory address generating circuit 400 includes a right rotator 415 and a bit reorder 416, collocating with the column counter 417 and the address counter 418 to finish all read and write actions.

According to the composition and the embodiments above, there are many advantages of the present invention over the prior art, such as:

1. Providing the test bench and the synthesis script could be compared automatically. It could accelerate developing time of IC design, and reduce processes of SOC integration.

2. The processing circuit has mixed-radix circuit module, which needs not a exclusive processing circuit for every radix. It could have lower cost and power consumption of FFT/IFFT processors.

3. The graphic user interface makes user to set parameters simply and completely for obtaining the RTL code or the C programming language model code.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An intellectual property builder, comprising:
a graphic user interface, setting a plurality of FFT/IFFT parameters, and providing a value of signal to noise ratio (SNR), and outputting a register transfer level code file, a test bench file, a synthesis script file and a C programming language model code;
a behavioral model, detecting a truncation error of hardware at a stage of system simulation;
a register transfer level model, comprising a core circuit module, the core circuit module comprises a radix-2 mode FFT/IFFT processor, a radix-2² mode FFT/IFFT processor, a radix-2³ mode FFT/IFFT processor and a mixed-radix controller, the register transfer level model could generate a register transfer level code;
an upper level connecting module, connecting a plurality of hardware module to obtain a circuit corresponding the plurality of FFT/IFFT parameters; and
a test module, comprising a plurality of test patterns for testing the register transfer level code.

2. The intellectual property builder of claim 1, wherein the plurality of FFT/IFFT parameters comprise a FFT/IFFT calculating point number, a coefficient length, a word length, a memory type and a test pattern.

3. The intellectual property builder of claim 1, wherein the intellectual property builder generates a synthesis script sample.

4. The intellectual property builder of claim 3, wherein the synthesis script sample comprises a plurality of parameters, and the plurality of parameters could be modified.

5. The intellectual property builder of claim 1, wherein the plurality of test patterns comprises a sine pattern, a cosine pattern and a random pattern.

6. A FFT/IFFT processor, comprising:
a memory;
a butterfly processor unit, having a pipeline multiple-path delay commutator, and the butterfly processor unit having a capability of pipeline mixed-radix calculation in accordance with pipeline multiple-path delay commutator; and
a memory control circuit, comprising a memory write circuit and a memory read circuit, and a shared memory structure could be composed of the memory write circuit and the memory read circuit.

7. The FFT/IFFT processor of claim 6, wherein the pipeline multiple-path delay commutator comprises a multiplexer, a delay and a control circuit.

8. The FFT/IFFT processor of claim 6, wherein the memory control circuit means for executing a mixed-radix algorithm.

9. The FFT/IFFT processor of claim 6, wherein the memory write circuit comprises a column counter, a address counter, a right rotator, a bit reorder, a switch and a delay.

10. The FFT/IFFT processor of claim 6, wherein the memory read circuit comprises a column counter, a address counter, a right rotator, a bit reorder, a switch and a delay.
